(19) United States
(12) Patent Application Publication
(10) Pub. No.: US 2011/0104489 A1
(43) Pub. Date: May 5, 2011

(54) HOLLOW CARBON FIBRES AND PROCESS FOR THEIR PRODUCTION

(75) Inventors: Michael Wolki, Dusseldorf (DE); Bernd Wohlmann, Dusseldorf (DE); Mathias Kaiser, Karlsbad (DE); Rudolf Emmerich, Kuppenheim (DE); Frank Henning, Pfinztal (DE)

(73) Assignee: TOHO TENAX CO., LTD., Sunto-gun, Shizuoka (JP)

(21) Appl. No.: 12/674,995

(22) PCT Filed: Sep. 17, 2008
(86) PCT No.: PCT/EP2008/062326

§ 371 Date: Feb. 24, 2010

(30) Foreign Application Priority Data
Oct. 11, 2007 (EP) 07019898.1

(51) Int. Cl. D02G 3/02; C01B 31/02; D02G 3/22

(52) U.S. Cl. 428/367; 204/157.47

(57) ABSTRACT

A process for the production of hollow carbon fibres by the treatment of a stabilised carbon fibre precursor in an application device using high-frequency electromagnetic waves. The application device includes structure supplying the electromagnetic waves to a outcoupling region and a hollow outer conductor terminating in the outcoupling region. For the treatment, a field of the high-frequency electromagnetic waves is generated and a field strength in the range from 15 to 40 kV/m is set in the outcoupling region of the application device. The stabilised carbon fibre precursor is conveyed continuously as an inner conductor through the hollow outer conductor, thereby forming a coaxial conductor having an outer and an inner conductor, and through the subsequent outcoupling region. An inert gas atmosphere is created in the coaxial conductor and in the outcoupling region by passing through an inert gas.

The invention relates to a process for continuous production of hollow carbon fibres and to the hollow carbon fibres produced by this process.

Hollow carbon fibres are employed for a wide range of applications, such as e.g. for adsorption/desorption tasks in removing impurities in low concentrations from gases or liquids, or in the field of liquid or gas separation, in which cases semi-permeable or even porous hollow carbon fibres are employed. Furthermore, hollow carbon fibres are also employed in the field of fibre composite materials.

The production of porous hollow carbon fibres is described, for example, in EP 0 394 449 A1. The process disclosed there provides for the spinning of solutions of a polyacrylonitrile (PAN)-based polymer A and a heat-decomposable (pyrolisable) polymer B by means of a hollow fibre nozzle to form a hollow fibre, and for the formation of a hollow fibre membrane formed from the polymers A and B by coagulation of these fibres. The hollow fibre membrane thus formed is subjected to an oxidation treatment and subsequently to a carbonisation during which the heat-decomposable polymer B decomposes to form constituents of low molecular weight that escape from the hollow fibre membrane. This results in a porous hollow fibre membrane.

EP 0 252 339 B1 also describes a process for producing a porous hollow carbon fibre membrane during which a pored membrane made from an acrylonitrile polymer is carbonised. The polyacrylonitrile membrane is pretreated with a hydrazine solution, subsequently preoxidised at a temperature in the range from 180 to 350° C. and finally carbonised at a temperature in the range from 600 to 3000° C. Electrically heated kilns are disclosed as equipment for performing the preoxidation and the carbonisation. The membranes described in EP 0 252 339 B1 are suitable for applications in the field of ultrafiltration and microfiltration and exhibit pore diameters in the range from 0.005 to 3 μm. Their wall thickness lies in the range from 5 to 200 μm. The hollow carbon fibre membrane disclosed in the sole embodiment has an inside diameter of 700 μm and a wall thickness of 120 μm. In view of the extensive precautionary measures necessary due to the use of the toxic and carcinogenic hydrazine, the process described in EP 0 252 339 B1 cannot be performed cost-effectively. Furthermore, the process described in both EP 0 252 339 B1 and in EP 0 394 449 A1 is limited in practice to the production of hollow carbon fibres with relatively large lumina and thick walls.

For use as reinforcements in composite materials, but also for applications in the field of adsorption and desorption, however, there is a demand for hollow carbon fibres with smaller lumina and thinner walls in addition to the hollow carbon fibres already available. However, such hollow carbon fibres cannot be produced using the processes known to date. At the same time, the prior-art processes are costly due to the necessary use of special mixtures of polymers in the starting materials or due to the use of health-endangering substances.

The object of the present invention is therefore to provide a process for production of hollow carbon fibres that is simpler than the prior-art processes, and by means of which hollow carbon fibres with small lumina and low wall thicknesses can also be produced that are also suitable for use as reinforcement fibres for composite materials. It is furthermore the object of the present invention to provide such hollow carbon fibres.

The object is achieved by a process for the production of hollow carbon fibres comprising the steps:
Provision of a stabilised carbon fibre precursor,
Provision of an application device for treatment of the stabilised carbon fibre precursor using high-frequency electromagnetic waves, said device comprising both means for supplying the electromagnetic waves to a outcoupling region and a hollow outer conductor terminating in the outcoupling region,
Generation of a field of the high-frequency electromagnetic waves and setting of a field strength in the range from 15 to 40 kV/m in the outcoupling region of the application device,
Continuous conveying of the stabilised carbon fibre precursor as an inner conductor through the hollow outer conductor, thereby forming a coaxial conductor consisting of the outer and the inner conductor, and through the subsequent outcoupling region, at the same time
Creating an inert gas atmosphere in the coaxial conductor and in the outcoupling region by passing through an inert gas.

Within the context of the present invention, stabilised carbon fibre precursors are to be understood as fibres that have been transformed into infusible fibres by process measures that are known per se. Only such infusible fibres are suitable for subsequent carbonisation steps that are necessary for production of carbon fibres. The starting materials can be the precursor materials made from polyacrylonitrile (PAN), pitch or rayon normally employed in the production of carbon fibres from which carbon fibres with good mechanical and adsorption properties are obtained after carbonisation. The stabilisation of the precursors is normally performed in air at approx. 150-300° C. As a result, an oxidised, infusible and hence stabilised fibre is obtained by chemical transformation. In a preferred embodiment of the process according to the invention, the fibres of the carbon fibre precursor have a solid cross-section and thus have no hollow volume.

When performing the process according to the invention, high-frequency electro-magnetic waves are generated, e.g. in a magnetron, that are guided by suitable means, preferably via a hollow-core waveguide, into the outcoupling region of the application device. In the outcoupling region, the field strength of the high-frequency electromagnetic waves is set to a level corresponding to a field strength in the outcoupling region in the range from 15 to 40 kV/m in the uncharged state, i.e. a state in which the stabilised carbon fibre precursor to be carbonised is not passing through the outcoupling region and an electric conductor is inserted instead.

In a preferred embodiment of the process according to the invention, the outcoupling region is a cavity resonator. In this case and in the simplest situation, the field strength is set in the range from 15 to 40 kV/m directly in the cavity resonator before insertion of the stabilised carbon fibre precursor to be carbonised, and then the precursor is inserted into the application device and conveyed through it. In a further preferred embodiment of the process of the invention, the outcoupling region is a hollow chamber in which a coupling cone is located to deliver the energy of the high-frequency electromagnetic waves supplied via e.g. a waveguide. In this case the field strength required by the invention is set by first inserting an electrical conductor, e.g. a metal wire, carbon fibre or hollow carbon fibre, through the hollow outer conductor and the hollow chamber and then a field is generated with a field strength in the range from 15 to 40 kV/m. In each case, the setting carried out to achieve the necessary field strength without the stabilised carbon fibre precursor being in the application device is maintained during the later conveying of the precursor to be treated, even though a change in the field strength occurs when the precursor passes through. Surprisingly, with the field strengths set to the values required by the invention, carbonised hollow fibres, in other words hollow carbon fibres, are obtained particularly even when using a carbon fibre precursor whose filaments exhibit a solid cross-section. It is naturally also possible to make the settings determined in preliminary trials for producing a field strength in the range from 15 to 40 kV/m in the uncharged resonator or uncharged hollow chamber during a later performance of the process according to the invention in the respective application device also during operation, i.e. while the precursor is passing through the application device, in order to obtain the desired hollow carbon fibre.

High-frequency electromagnetic waves with a frequency of 300 MHz to 300 GHz, generally known as microwaves, are preferred. Particularly preferred are microwaves in the range from 900 MHz to 10 GHz. As standard, microwaves with a frequency of 915 MHz to 2.45 GHz are used that are ideally suited for performing the process of the invention.

The use of microwave energy for the production of carbon fibres is already known. In view of the characteristics of the precursor materials employed and the material changes that take place, particular demands are made on the process control and process management with respect to the achievement of a homogeneous and continuous fibre treatment. Fibres, yarns and strands of stabilised precursor fibres are poor conductors of electricity and only moderate absorbers of high-frequency electromagnetic waves such as microwaves. The irradiation with the high-frequency electromagnetic waves marks the start of the transition to complete carbonisation and increasing graphitisation, resulting in a sharp increase in the electrical conductivity of the treated fibres. When the graphitisation has been completed, the fibre behaves like a wire in the waveguide and results in strong distortion and disturbance of the electric field in the waveguide or in the resonator arrangement. Without control, inhomogeneities and disturbances occur that influence the homogeneity and process stability of the graphitisation, or in extreme cases can lead to ignition of discharges and electric arcing or the thermal vaporisation of the fibres.

A process for production of carbon fibres from pitch by means of microwaves is known from U.S. Pat. No. 4,197,282 A. It is reported on this process that the microwave treatment can only be performed after a preparatory heat treatment of the stabilised precursor in an inert atmosphere at 450 to 1000° C. According to U.S. Pat. No. 4,197,282 A, the heat treatment causes the precursor fibres to be transformed to such an extent (mesophase in the case of pitch fibres) that they can be excited by the high frequency of the microwave. The process according to U.S. Pat. No. 4,197,282 A produces carbon fibres that can be employed as reinforcement fibres in composite materials and whose filaments have a solid cross-section.

The unpublished European patent application No. 06007926.6 describes a process for continuous production of carbon fibres in which stabilised precursor fibres are continuously conveyed, as the inner conductor of a coaxial conductor consisting of an outer and an inner conductor, through the coaxial conductor and a treatment zone, the stabilised precursor fibres are irradiated in the treatment zone with high-frequency electromagnetic waves, preferably microwaves, that are absorbed by the precursor fibres, whereby the precursor fibres are heated and are transformed into carbon fibres. The stabilised precursor fibres or the carbon fibres are conveyed through the coaxial conductor and the treatment zone under an inert gas atmosphere. Even when using the process disclosed in this document, however, no hollow carbon fibres are obtained. In the process described there, microwave energy is supplied from a rectangular waveguide into a coaxial conductor, for example via a coupling cone, in a similar way to that described in DE 10 2004 021 016 A1. By contrast with the coaxial conductor employed in DE 10 2004 021 016 A1 in which both the outer and the inner conductors are fixed components of the coaxial conductor, the inner conductor in the process described in the unpublished European patent application No. 06007926.6 is formed by the stabilised precursor fibres that are continuously conveyed through the outer conductor, whereby the stabilised precursor fibres in the cited European patent application are preferably to be understood as precarbonised precursor fibres. The process of the invention is based on the process described in the unpublished European patent No. 06007926.6, to the disclosure of which reference is hereby explicitely made.

When carrying out of the process according to the invention, the provided stabilised carbon fibre precursor is introduced into the application device via the hollow outer conductor terminating in the outcoupling region and is conveyed continuously through the hollow outer conductor. A coaxial conductor is thereby formed, with the hollow outer conductor taking on the function of the outer conductor and the precursor conveyed in the outer conductor taking on the function of the inner conductor. After leaving the coaxial conductor, the already partially treated precursor passes through the subsequent outcoupling region and leaves the outcoupling region on the side of the outcoupling region facing away from the coaxial conductor and leaves the application device as a carbonised hollow carbon fibre.

As the stabilised carbon precursor fibres have a very low conductivity, the energy of the high-frequency electromagnetic waves causes the precursor fibres to be heated by absorption in the outcoupling region. With increasing heating, the precursor fibres are transformed into a material that initially absorbs better and is thus heated better, and due to the increasing heating is also carbonised so that carbon fibres are now produced from the precursor fibres. As a result of this transformation, the conductivity of the resulting carbon fibres increases so that the energy of the high-frequency electromagnetic waves is increasingly delivered into the coaxial junction, thereby preventing further treatment of the carbon fibres. The delivered energy of the high-frequency electromagnetic waves starts the treatment of the precursor fibres already in the coaxial conductor, so that a self-regulating system is established as the precursor fibres are conveyed through the coaxial conductor. In the process, a short reaction or treatment zone, usually only a few centimetres in length, is formed in a zone of the outcoupling region to which the energy of the high-frequency electromagnetic waves is delivered, and in a part of the coaxial conductor, in which zone at least the greater part of the transformation reaction to produce the hollow carbon fibres occurs.

For performing the process of the invention it is necessary for high-frequency electromagnetic waves with sufficiently high energy to be supplied to the stabilised precursor in the treatment zone. As already described, there is a field of electro-magnetic waves in the outcoupling region whose field strength is set such that an electric field strength of between 15 and 40 kV/m is created in the uncharged outcoupling region. Even with the precursor to be carbonised inserted, this field has sufficiently high energy that during the carbonisation, a continuous cavity or lumen is formed in the filaments of the precursor provided, and hence hollow carbon fibres are formed.

Without wishing to be bound by the theory, it is suspected that when performing the process according to the invention, the volumetric heating of the precursors is so rapid and pronounced due to the absorption of the microwaves when an electric field with a field strength of more than 15 kV/m is applied that the transformation processes, i.e. the at least partial carbonisation of the precursor, are accelerated. The speed of the transformation processes is thereby so pronounced that the gases containing oxygen, nitrogen and hydrogen produced during carbonisation cannot be discharged rapidly enough from the transforming precursor material, as a result of which a hollow structure, i.e. hollow carbon fibres, is created. At the same time, an increase in the volume of the transforming precursor material due to the generation and delayed discharge of the gases is observed, so that the cross-section of the resulting hollow carbon fibres is increased compared with the cross-section of the stabilised precursor fibres provided. Overall it is of course necessary for the fibres to still have a sufficiently plastic behaviour during the gas development process. Below a field strength of 15 kV/m, on the other hand, the transformation processes still take place relatively slowly so that the gases are formed relatively slowly and at the same time can escape rapidly enough, resulting in the formation of solid filaments. Above a field strength of 40 kV/m, on the other hand, stable process conditions for the carbonisation can no longer be achieved. In some cases the filaments are destroyed. In a preferred embodiment of the process of the invention, the field strength lies in the range from 20 to 30 kV/m.

As explained above, gases are released during the carbonisation of the precursor. For the formation of the cavity structure in the resulting carbon fibres it is obviously necessary that on the one hand, these gases are formed so quickly during the carbonisation that they cannot be discharged rapidly enough. On the other hand, this presupposes at the same time that the precursor provided has a sufficiently high percentage of such constituents that result in gaseous products during the carbonisation before it is subjected to the treatment according to the invention with high-frequency electromagnetic waves. This percentage depends on the one hand on the material of the precursor provided, and on the other hand it changes, e.g. depending on the oxidation conditions set for the stabilisation of the precursor. It was observed that the percentage of constituents that result in gaseous products during carbonisation is predominantly influenced by the duration of the oxidation treatment and by the temperature during oxidation. The stabilised carbon fibre precursor employed in the process according to the invention preferably contains a proportion of the elements H, N and O which become volatile during carbonisation of at least 30 wt. % and particularly preferably of at least 35 wt. %. The proportion of these elements can be determined in a simple manner using the normal methods of element analysis. Under these conditions, hollow carbon fibres are obtained in a preferred embodiment that in addition to the hollow structure, i.e. in addition to the lumen, also exhibit porous walls. Due to their large surface area, such hollow carbon fibres are particularly suitable for, e.g. adsorption and desorption applications.

In a further preferred embodiment of the process of the invention, the stabilised carbon fibre precursor is made from polyacrylonitrile. In a preferred embodiment of the process of the invention, stabilised precursor yarns can generally be employed that are normally used for the production of carbon fibres employed as reinforcement fibres in composite materials. Preferred precursor yarns consist of 1000 to 24000 filaments, such filaments having a diameter of between 7 and 20 μm. Using such preferred precursor yarns, hollow carbon fibres with low diameter and low wall thickness can be produced by means of the process according to the invention that could not be provided using the prior art processes.

The present invention therefore relates also to a hollow carbon fibre having a continuous lumen extending in the longitudinal axis of the fibre, such hollow carbon fibre having an inside diameter in the range between 5 and 20 μm and a wall thickness in the range between 1.5 and 7 μm. The inside diameter preferably lies in the range between 8 and 15 μm and the wall thickness in the range between 2 and 5 μm. In an advantageous embodiment, the hollow carbon fibre according to the invention has a wall with porous structure.

The inert gas atmosphere around the stabilised precursor fibres in the outcoupling region and in the coaxial conductor required by the invention can be maintained in a simple manner, for example, by arranging a tube transparent to the energy of the high-frequency electromagnetic waves or microwaves inside the outer conductor of the coaxial conductor and the treatment zone, and passing the stabilised precursor fibres as an inner conductor and also the inert gas through this tube. Materials for this tube can be ceramic materials such as e.g. quartz, aluminium oxide and other similar materials. It has proved to be advantageous if the gas employed for the generation of the inert gas atmosphere is nitrogen. It is particularly advantageous if small volumes of oxygen are admixed to the inert gas atmosphere. In this way it is possible with the process according to the invention to carry out the oxidation step of the treatment normally performed after completion of the carbonisation at the same time as the carbonisation. The addition of oxygen can be achieved, for example, by not removing the air contained between the precursor fibres before insertion into the coaxial conductor. However, it is also possible to add the oxygen at a selective uniform rate to the inert gas atmosphere.

A preferred embodiment of the process of the invention is characterised in that the stabilised precursor fibres are conveyed at such a velocity through the coaxial conductor that they are completely carbonised on leaving the coaxial conductor in the treatment zone. Complete carbonisation is understood here as a carbonisation by which a carbon fibre with a carbon content of at least 75 wt. % is obtained.

It is particularly favourable if the velocity at which the stabilised precursor fibres are conveyed through the coaxial conductor is controlled via the measurement of the electrical resistance of the hollow carbon fibre produced. It has been observed in fact that the value of the electrical resistance allows conclusions to be drawn about the quality of the hollow carbon fibres. When performing the process according to the invention, it was observed that precursor fibres that have already been carbonised still have an electrical resistance on the order of 30 MΩ, while carbon fibres with a high percentage of carbon have an electrical resistance on the order of a few Ω, for example in the range from 10 to 50Ω. The electrical resistance is measured here using two copper electrodes positioned 50 cm apart on the fibres.

It is also possible to perform the process according to the invention in such a way that the stabilised precursor fibres are conveyed through two or more successive reactors consisting of coaxial conductor and treatment zone.

The hollow carbon fibres produced by means of the process of the invention can be advantageously employed for applications in the field of adsorption/desorption, for example, for cleaning gases or liquids. For this application, the hollow fibres can also be subjected to an activation in a subsequent treatment step. Furthermore, the hollow carbon fibres produced by means of the process according to the invention or the hollow carbon fibres according to the invention can be particularly employed for reinforcing plastics, i.e. for the production of fibre composite materials. The use of the hollow carbon fibres according to the invention instead of carbon fibres whose filaments have a solid cross-section allows composite materials to be produced with a 25% to 50% lower weight. This is of particular advantage when producing components that must be dimensionally stable, such as e.g. concave optical reflectors.

Suitable devices for performing the process according to the invention are described in greater detail below:

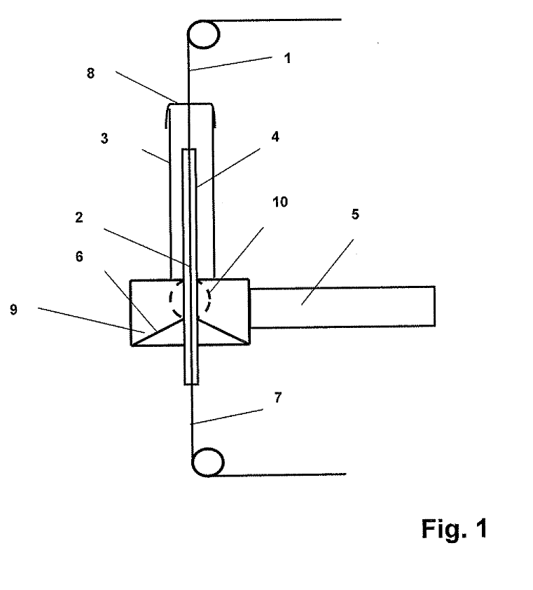

FIG. 1 is a schematic representation of an application device in which outcoupling of the energy of the high-frequency electromagnetic waves occurs via a coupling cone in a hollow chamber,

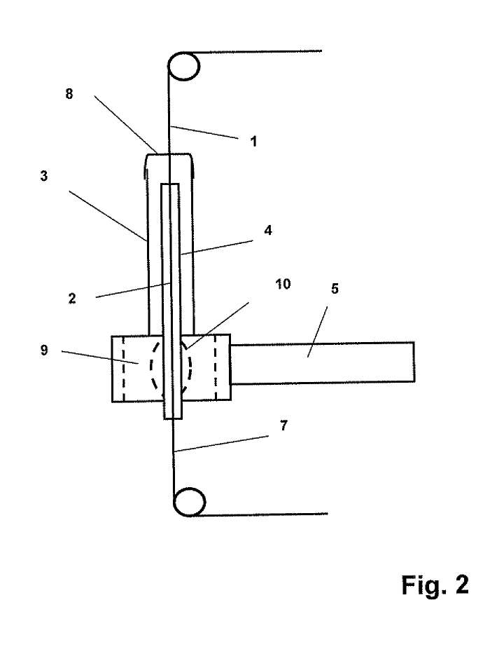

FIG. 2 is a schematic representation of an application device in which a cavity resonator is used for outcoupling of the energy of the high-frequency electromagnetic waves.

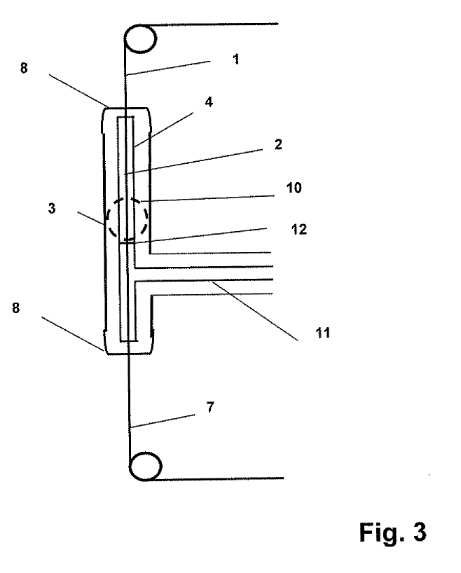

FIG. 3 is a schematic representation of a device in which a coaxial feed is used for outcoupling of the energy of the high-frequency electromagnetic waves.

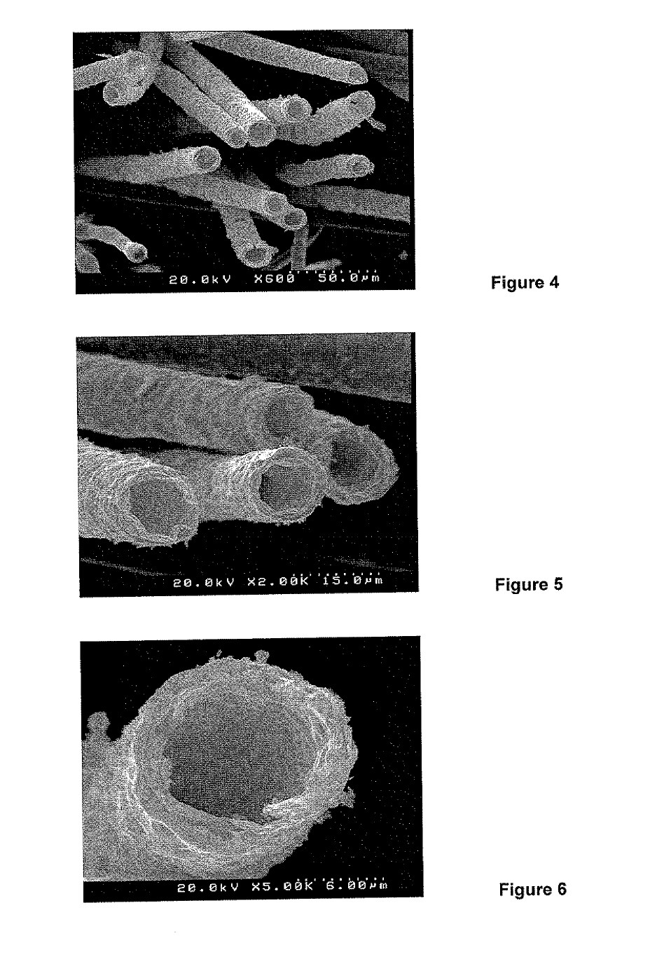

FIG. 4 is a scanning electron microscopic (SEM) image of hollow carbon fibres of the invention according to Example 1, magnification 600:1.

FIG. 5 is an SEM image of hollow carbon fibres of the invention according to Example 1, magnification 2000:1.

FIG. 6 is an SEM image of the cross-section of an hollow carbon fibre of the invention according to Example 1, magnification 5000:1.

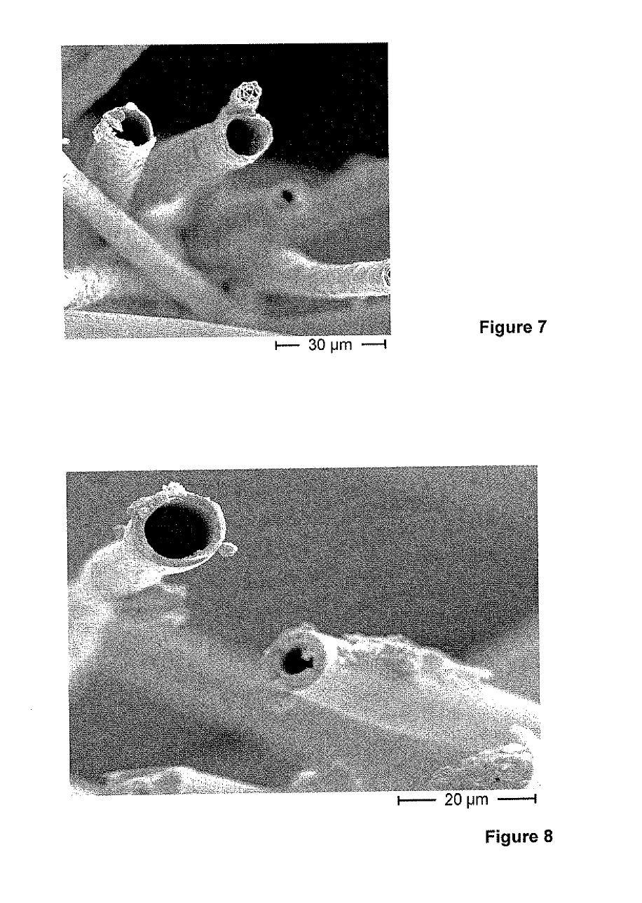

FIG. 7 is a scanning electron microscopic (SEM) image of hollow carbon fibres of the invention according to Example 2.

FIG. 8 is an SEM image of hollow carbon fibres of the invention according to Example 2.

For performing the process according to the invention, stabilised precursor fibres 1 are guided as inner conductors 2 through a hollow outer conductor 3 to form a coaxial conductor. The high frequency electromagnetic waves supplied via hollow-core waveguide 5 are delivered via a coupling cone 6 (FIG. 1) in a hollow chamber 9 or via cavity resonator 9 (FIG. 2), in a treatment zone 10 thus formed and into the coaxial conductor 2, 3 consisting of inner conductor 2 and hollow outer conductor 3 and are coupled out into the coaxial conductor 2,3 as a result of the transformation into carbon fibres. Positioned around the inner conductor 2 and inside the outer conductor 3 and inside the hollow chamber 9 or cavity resonator 9 is a tube 4 that is transparent to high-frequency electromagnetic waves or microwaves made, for example, of a quartz material, through which an inert gas is passed for creating an inert gas atmosphere. On leaving the treatment zone 10, the stabilised precursor fibres 1 have been transformed into hollow carbon fibres 7. A field distribution of the energy of the electromagnetic waves in the form of standing waves is achieved in the coaxial conductor by means of a coaxial termination unit 8. Other embodiments suitable for carrying out the process of the invention are described, for example, in DE 26 16 217, EP 0 508 867 or WO 00/075 955.

As shown in FIG. 3, the high-frequency electromagnetic waves are supplied via a T-shaped coaxial conductor whose inner conductor 11 is electrically conductive. The outer conductor of the T-shaped coaxial conductor is formed by the hollow outer conductor 3 and a lateral extending perpendicularly from the latter. The inner conductor 11 can, for example, have a tubular form. The energy of the high-frequency electromagnetic waves is diverted to the treatment zone 10 via the T-shaped coaxial conductor and coupled out into the outcoupling region located above the upper end 12 of the T-shaped inner conductor that at the same time forms the treatment zone 10. Above the upper end 12 of the T-shaped inner conductor, the electrically conductive inner conductor 11 has a junction to a tube 4 that is transparent to high-frequency electromagnetic waves or microwaves and made, for example, of quartz. Above the junction 12, i.e. in the region of the tube 4, the stabilised precursor fibres take over the function of the inner conductor 2 of the coaxial conductor whose outer conductor is indicated by the number 3.

The invention is described in further detail by reference to the following examples:

### EXAMPLE 1

A stabilised carbon fibre precursor of polyacylonitrile was provided, said carbon fibre precursor having 12,000 filaments with a filament diameter of approx. 8 μm. According to the element analysis, the proportion of the elements H, N and O in the precursor which become volatile during carbonisation was 35.1 wt. %.

The configuration of the application device employed for the microwave treatment corresponded to that of the device shown in FIG. 2. A cylindrical resonator with aluminium walls and a diameter of 100 mm supplied by Muegge Electronics GmbH was used for coupling in the microwave energy. Microwaves with a wavelength of 2.45 GHz were generated in a microwave generator and supplied to the resonator via an R 26 rectangular hollow-core waveguide connected to the microwave generator. A field strength of 30 kV/m was set in the resonator. From the resonator the microwave energy was coupled out into a coaxial conductor whose hollow outer conductor had an inside diameter of 100 mm.

Arranged coaxially inside the hollow outer conductor was a quartz tube that extended through the resonator and terminated outside the resonator. Nitrogen flowed through the quartz tube at a volumetric flow rate of 25 l/min.

The stabilised carbon fibre precursor was subsequently inserted into the hollow outer conductor and conveyed continuously through the quartz tube at a velocity of 50 m/h, thereby producing a coaxial conductor consisting of the precursor (inner conductor) and hollow outer conductor. In the region of the resonator and in the outcoupling region to the coaxial conductor, the carbon fibre precursor was exposed to the microwave energy and the microwave energy was absorbed by the precursor. As a result, the precursor was heated and a carbonisation of the precursor took place, at the same time forming a hollow fibre. As can be seen from the SEM images in FIGS. 4 to 6, this resulted in hollow carbon fibres having a porous wall structure, an inside diameter of approx. 10 μm and a wall thickness of approx. 2-3 μm.

### EXAMPLE 2

The stabilised carbon fibre precursor of polyacrylonitrile with 12,000 filaments and a filament diameter of approx. 8 μm used in Example 1 was provided and the same device as used in Example 1 was employed.

In deviation from Example 1, a field strength of 30 kV/m was set in the resonator and the carbon fibre precursor was conveyed through the device at a velocity of 250 m/min in the present example.

As can be seen from the SEM images in FIGS. 7 and 8, the resulting hollow carbon fibres had a smooth wall structure, an inside diameter of approx. 9 μm and a wall thickness of approx. 1.5-2 μm.

### COMPARATIVE EXAMPLE

A carbon fibre precursor of polyacrylonitrile with 12,000 filaments and a filament diameter of approx. 7 μm was employed. The carbon fibre precursor had already been subjected to precarbonisation, so that the proportion of the volatile elements H, N and O in the precursor during carbonisation was reduced to 28.7 wt. %.

The application device used in Example 1 was employed again, with the microwave energy in the uncharged resonator also being set to a field strength of 30 kV/m. The carbon fibre precursor was conveyed through the device at a velocity of 50 m/min.

No hollow carbon fibres were obtained. The filaments of the carbon fibres obtained in this Comparative Example had a solid cross-section.

1. Process for continuous production of hollow carbon fibres comprising:
providing a stabilised carbon fibre precursor,
providing an application device for treatment of the stabilised carbon fibre precursor using high-frequency electromagnetic waves, said device comprising both means for supplying the electromagnetic waves to a outcoupling region and a hollow outer conductor terminating in the outcoupling region,
generating a field of the high-frequency electromagnetic waves and setting of a field strength in the range from 15 to 40 kV/m in the outcoupling region of the application device,
continuously conveying of the stabilised carbon fibre precursor as an inner conductor through the hollow outer conductor, thereby forming a coaxial conductor having the outer and the inner conductor, and through the subsequent outcoupling region, at the same time, and
creating an inert gas atmosphere in the coaxial conductor and in the outcoupling region by passing through an inert gas.

2. Process according to claim 1, wherein the outcoupling region is formed by a cavity resonator from which the electromagnetic waves are coupled out into the coaxial conductor.

3. Process according to claim 1, wherein the outcoupling region is formed by a chamber having a coupling cone via which the high-frequency electromagnetic waves are delivered into the coaxial conductor.

4. Process according to claim 1, wherein a field strength of 20 to 30 kV/m is generated in the outcoupling region of the application device.

5. Process according to claim 1, wherein the application device has an inner tube made of a material transparent to high-frequency electromagnetic waves, said inner tube being arranged concentrically in the hollow outer conductor and extending over at least part of the length of the outer conductor, whereby the carbon fibre precursor is conveyed through the inner tube and the inert gas is passed through the inner tube.

6. Process according to claim 1, wherein the stabilised carbon fibre precursor has no hollow volume.

7. Process according to claim 1, wherein the stabilised carbon fibre precursor contains a proportion of the elements H, N and O which become volatile during carbonisation of at least 30 wt. %.

8. Process according to claim 7, wherein the proportion of the elements H, N and O in the stabilised carbon fibre precursor is at least 35 wt. %.

9. Process according to claim 1, wherein the stabilised carbon fibre precursor is made from polyacrylonitrile.

10. Process according to claim 1, wherein nitrogen is used for the generation of the inert gas atmosphere through which the stabilised carbon fibre precursor is conveyed.

11. Process according to claim 1, wherein small volumes of oxygen are admixed to the inert gas atmosphere.

12. Process according to claim 1, wherein the velocity at which the stabilised precursor fibres are conveyed through the application device is controlled via the measurement of the electrical resistance of the hollow carbon fibre produced.

13. Process according to claim 1, wherein the stabilised precursor fibres are conveyed through the application device at such a velocity that they are completely carbonised on leaving the application device.

14. Process according to claim 1, wherein the stabilised precursor fibres are conveyed through two or more successive application devices.

15. Hollow carbon fibre having a continuous lumen extending in a longitudinal axis of the fiber, wherein the fibre has an inside diameter in the range between 5 and 20 μm and a wall thickness in the range between 1.5 and 7 μm.

16. Hollow carbon fibre according to claim 15, wherein the fiber has an inside diameter in the range between 8 and 15 μm and a wall thickness in the range between 2 and 5 μm.

17. Hollow carbon fibre according to claim 15, wherein a fiber wall has a porous structure.
